(19) United States
(12) Patent Application Publication
(10) Pub. No.: US 2024/0086775 A1
(43) Pub. Date: Mar. 14, 2024

(54) SYSTEMS AND RELATED METHODS FOR DEVELOPING ARTIFICIAL INTELLIGENCE APPLICATIONS BASED ON MACHINE LEARNED MODELS

(71) Applicant: DataRobot, Inc., Boston, MA (US)

(72) Inventors: Jeremy Achin, Boston, MA (US); Ina Ko, Old Bridge, NJ (US); Borys Kupar, Munich (DE); Tristan Spaulding, Arlington, MA (US); Yulia Bezuhla, Kyiv (UA); Brett Rowley, Cambridge, MA (US); Colleen Wilhide, Boston, MA (US)

(73) Assignee: DataRobot, Inc., Boston, MA (US)

(21) Appl. No.: 18/506,392

(22) Filed: Nov. 10, 2023

Related U.S. Application Data
(63) Continuation of application No. PCT/US2022/028567, filed on May 10, 2022.
(60) Provisional application No. 63/187,345, filed on May 11, 2021.

(51) Int. Cl. G06N 20/00

(52) U.S. Cl. CPC G06N 20/00

(57) ABSTRACT

Presented herein are methods and systems for generating and executing applications that provide insights to a model's operation without requiring the user to have knowledge of coding, computer programming, or artificial intelligence machine-learning methodologies. An exemplary method includes deploying a model using input data to generate a predicted dataset; presenting indications for a plurality of applications associated with the deployed model including an configured to generate new scenarios and another application configured to optimize at least one feature; presenting a plurality of features analyzed by the model; and in response to receiving a selection of a feature of the plurality of features and a new value for the feature, executing the first application to generate a second predicted dataset using the new value.

### CROSS-REFERENCE TO RELATED APPLICATIONS

This application claims the benefit of priority under 35 U.S.C. § 120 as a continuation of International Patent Application No. PCT/US2022/028567, filed May 10, 2022, and designating the United States, which claims the benefit of and priority under 35 U.S.C. § 119 to U.S. Provisional Patent Application No. 63/187,345, filed May 11, 2021, each of which is hereby incorporated herein by reference in its entirety for all purposes.

### TECHNICAL FIELD

The present implementations relate generally to generating applications for analyzing and forecasting machine learning models and systems, and more particularly to generating a user interface presenting a prediction or explanation of input and output data.

### BACKGROUND

Understanding behavior of complex systems is increasingly important to commercial success in business and favorable outcomes. With recent advances in technology, many complex systems use computer models that utilize artificial intelligence (AI) or machine learning (ML) techniques to output data. Therefore, understanding how AI/ML models behave is desired.

### SUMMARY

For the aforementioned reasons, users may desire to gain insight as to how a computer model utilizing AI/ML techniques reached a conclusion. Users may use this insight as context to make better decisions using the model. Users may also desire to optimize a result or generate new scenarios indicating how predictions outputted by the model may change given a revised or an alternative input. However, some systems and software solutions cannot efficiently and effectively inform users of a model's operations (e.g., factors contributing to behavior of the model) with sufficient granularity. Moreover, some systems and software solutions require users to perform (or at least have the knowledge of) complex programming and coding to generate customized code that would provide insight regarding the model, optimize an attribute, and/or generate an alternative scenario. Moreover, some modeling techniques may require the user to execute the model using revised/alternative input data to provide a new scenario for the user, which is highly inefficient and requires high processing power.

Present implementations can include applications (or widgets) generated that are associated with deployed or existing models where the generation of the applications can be achieved using user interfaces without necessarily having coding or knowledge of computer science, AI, or ML techniques. The applications (or widgets) may allow the user to optimize one or more features of the model. For instance, the application may display a list of predicted outcomes generated by a model that has been deployed or is otherwise in use. Using the applications discussed herein, a user may optimize an outcome, such that the application can display how certain attributes change to achieve the optimized results desired by the user.

Additionally or alternatively, another application (alternative scenario builder application) discussed herein may allow the user to generate alternative scenarios. For instance, a user may desire to see how predictions of a model may change given a new attribute or a revised input value. The alternative scenario builder application (sometimes referred to as the what-if application) can display a new alternative prediction dataset that indicates how various results would change given a new attribute.

One aspect is directed to a method. The method may include deploying, by a data processing system comprising one or more processors coupled to memory, a model using input data to generate a predicted dataset via machine learning. The method may include presenting, by the data processing system on a user interface, a plurality of indications for a plurality of applications associated with the deployed model, a first application from the plurality of applications configured to generate new scenarios and a second application from the plaurlity of applications configured to optimize at least one feature of the deployed model. The method may include in response to receiving a selection of the first application, presenting, by the data processing system on the user interface, a plurality of features analyzed by the model. The method may include in response to receiving a selection of a feature of the plurality of features and a new value for the feature presenting, by the data processing system, an error message when the new value does not comply with a defined criteria; and executing, by the data processing system, the first application to generate a second predicted dataset using the new value.

The method may further comprise ranking, by the data processing system, the plurality of features based on an importance value of the plurality of features; and presenting, by the data processing system, the plurality of features based on the ranking.

The plurality of features corresponds to categorical features.

The plurality of features corresponds to numerical features.

The method may further comprise filtering, by the data processing system, the plurality of features in accordance with an impact value threshold.

The method may comprise in response to receiving a selection of the second application, presenting, by the data processing system on the user interface, the plurality of features analyzed by the computer model; and in response to receiving a selection of at least one feature, executing the second application to generate an alternative predicted dataset that includes an optimized value for the selected at least one feature.

The method may further comprise present, by the data processing system, a subset of the plurality of features analyzed by the computer model as flexible feature when the subset of the plurality of features includes an attribute that contributes to the optimized value.

The method may further comprise receiving, by the data processing system, a constraint value indicating a range of the optimized value.

The method may further comprise presenting, by the data processing system on the user interface, a graphical indicator corresponding to a value associated with the selected feature within the predicted dataset and a second graphical indicator corresponding to a second value associated with the selected feature within the alternative predicted dataset.

The method may further comprise generating, by the data processing system, an electronic document the second predicted dataset using the new value.

Another aspect is directed towards a computer system. The computer system may comprise a server of a data processing system comprising one or more processors coupled to memory, the server configured to deploy a model using input data to generate a predicted dataset via machine learning; present, on a user interface, a plurality of indications for a plurality of applications associated with the deployed model, a first application from the plurality of applications configured to generate new scenarios and a second application from the plaurlity of applications configured to optimize at least one feature of the deployed model; in response to receiving a selection of the first application, present, on the user interface, a plurality of features analyzed by the model; in response to receiving a selection of a feature of the plurality of features and a new value for the feature present an error message when the new value does not comply with a defined criteria; and execute the first application to generate a second predicted dataset using the new value.

The server may be further configured to rank the plurality of features based on an importance value of the plurality of features; and presenting, by the data processing system, the plurality of features based on the ranking.

The plurality of features corresponds to categorical features.

The plurality of features corresponds to numerical features.

The server may be further configured to filter the plurality of features in accordance with an impact value threshold.

The server may be further configured to in response to receiving a selection of the second application, present, on the user interface, the plurality of features analyzed by the computer model; and in response to receiving a selection of at least one feature, executing the second application to generate an alternative predicted dataset that includes an optimized value for the selected at least one feature.

The server may be further configured to present a subset of the plurality of features analyzed by the computer model as flexible feature when the subset of the plurality of features includes an attribute that contributes to the optimized value.

The server may be further configured to generate an electronic document the second predicted dataset using the new value.

Another aspect is directed towards a computer system. The computer system may comprise a server comprising a processor and a non-transitory computer-readable medium containing instructions that when executed by the processor causes the processor to perform operations comprising deploying a model using input data to generate a predicted dataset via machine learning; presenting, on a user interface, a plurality of indications for a plurality of applications associated with the deployed model, a first application from the plurality of applications configured to generate new scenarios and a second application from the plaurlity of applications configured to optimize at least one feature of the deployed model; in response to receiving a selection of the first application, presenting, on the user interface, a plurality of features analyzed by the model; in response to receiving a selection of a feature of the plurality of features and a new value for the feature: presenting an error message when the new value does not comply with a defined criteria; and executing the first application to generate a second predicted dataset using the new value.

The instruction may further cause the processor to in response to receiving a selection of the second application, presenting the plurality of features analyzed by the computer model; and in response to receiving a selection of at least one feature, executing the second application to generate an alternative predicted dataset that includes an optimized value for the selected at least one feature.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a computer system for a data processing system (sometimes referred to as the system) performing the methods and features discussed herein, in accordance with an embodiment.

FIG. 2 illustrates a flowchart depicting operational steps executed by the data processing system is depicted, in accordance with an embodiment.

FIG. 3-24 illustrate various graphical user interfaces generated and/or presented by the data processing system, in accordance with various embodiments.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations.

Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

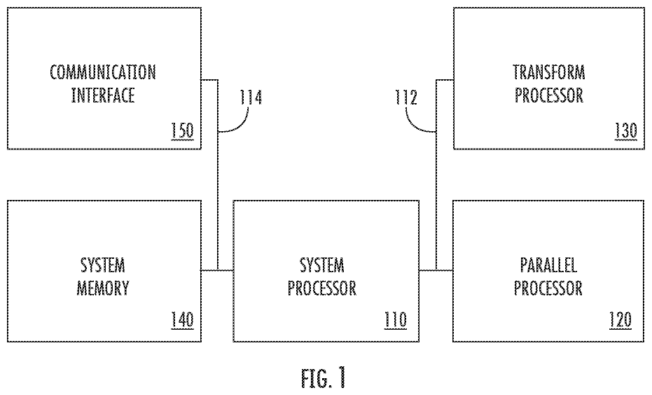

FIG. 1 illustrates a computer system in accordance with present implementations. As illustrated by way of example in FIG. 1, an example processing system 100 includes a system processor 110, a parallel processor 120, a transform processor 130, a system memory 140, and a communication interface 150. In some implementations, at least one of the example processing system 100 or the system processor 110 includes a processor bus 112 and a system bus 114.

The system processor 110 can execute one or more instructions. The instructions can be associated with at least one of the system memory 140 or the communication interface 150. The system processor 110 can include an electronic processor, an integrated circuit, or the like including one or more of digital logic, analog logic, digital sensors, analog sensors, communication buses, volatile memory, nonvolatile memory, and the like. The system processor 110 can include but is not limited to, at least one microcontroller unit (MCU), microprocessor unit (MPU), central processing unit (CPU), graphics processing unit (GPU), physics processing unit (PPU), embedded controller (EC), or the like.

In some implementations, the system processor 110 can include a memory operable to store or storing one or more instructions for operating components of the system processor 110 and operating components operably coupled to the system processor 110. The one or more instructions can include at least one of firmware, software, hardware, operating systems, embedded operating systems, or the like.

The processor bus 112 can communicate one or more instructions, signals, conditions, states, or the like between one or more of the system processor 110, the parallel processor 120, and the transform processor 130. The processor bus 112 can include one or more digital, analog, or like communication channels, lines, traces, or the like. It is to be understood that any electrical, electronic, or like devices, or components associated with the system bus 114 can also be associated with, integrated with, integrable with, supplemented by, complemented by, or the like, the system processor 110 or any component thereof.

The system bus 114 can communicate one or more instructions, signals, conditions, states, or the like between one or more of the system processor 110, the system memory 140, and the communication interface 150. The system bus 114 can include one or more digital, analog, or like communication channels, lines, traces, or the like. It is to be understood that any electrical, electronic, or like devices, or components associated with the system bus 114 can also be associated with, integrated with, integrable with, supplemented by, complemented by, or the like, the system processor 110 or any component thereof.

The parallel processor 120 can execute one or more instructions concurrently, simultaneously, or the like. The parallel processor 120 can execute one or more instructions in a parallelized order in accordance with one or more parallelized instruction parameters. Parallelized instruction parameters can include one or more sets, groups, ranges, types, or the like, associated with various instructions. The parallel processor 120 can include one or more execution cores variously associated with various instructions. The parallel processor 120 can include one or more execution cores variously associated with various instruction types or the like. The parallel processor 120 can include an electronic processor, an integrated circuit, or the like including one or more of digital logic, analog logic, communication buses, volatile memory, nonvolatile memory, and the like. The parallel processor 120 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the parallel processor 120 can also be associated with, integrated with, integrable with, supplemented by, complemented by, or the like, the system processor 110 or any component thereof.

Various cores of the parallel processor 120 can be associated with one or more parallelizable operations in accordance with one or more metrics, engines, models, and the like. As one example, parallelizable operations include processing portions of an image, video, waveform, audio waveform, processor thread, one or more layers of a learning model, one or more metrics of a learning model, one or more models of a learning system, and the like. A predetermined number or predetermined set of one or more particular cores of the parallel processor 120 can be associated exclusively with one or more distinct sets of corresponding metrics, engines, models, and the like.

Thus, the parallel processor 120 can parallelize execution across one or more metrics, engines, models, and the like. Similarly, a predetermined number or predetermined set of one or more particular cores of the parallel processor 120 can be associated collectively with corresponding metrics, engines, models, and the like. As one example, a first plurality of cores of the parallel processor can be assigned to, associated with, configured to, fabricated to, or the like, execute one engines providing the functionality discussed herein. In this example, a second plurality of cores of the parallel processor can also be assigned to, associated with, configured to, fabricated to, or the like, execute another engine providing the functionality discussed herein. Thus, the parallel processor 120 can parallelize execution within one or more metrics, engines, models, and the like.

The transform processor 130 can execute one or more instructions associated with one or more predetermined transformation processes. As one example, transformation processes include Fourier transforms, matrix operations, calculus operations, combinatoric operations, trigonometric operations, geometric operations, encoding operations, decoding operations, compression operations, decompression operations, image processing operations, audio processing operations, and the like. The transform processor 130 can execute one or more transformation processes in accordance with one or more transformation instruction parameters. Transformation instruction parameters can include one or more instructions associating the transform processor 130 with one or more predetermined transformation processes. The transform processor 130 can include one or more transformation processes. The transform processor 130 can include a plurality of transform processors 130 variously associated with various predetermined transformation processes. The transform processor 130 can include a plurality of transformation processing cores each associated with, configured to execute, fabricated to execute, or the like, a predetermined transformation process.

The transform processor 130 can include an electronic processor, an integrated circuit, or the like including one or more of digital logic, analog logic, communication buses, volatile memory, nonvolatile memory, and the like. The transform processor 130 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the transform processor 130 can also be associated with, integrated with, integrable with, supplemented by, complemented by, or the like, the system processor 110 or any component thereof.

The transform processor 130 can be associated with one or more predetermined transform processes in accordance with one or more metrics, engines, models, and the like. A predetermined transform process of the transform processor 130 can be associated with one or more corresponding metrics, engines, models, and the like. As one example, the transform processor 130 can be assigned to, associated with, configured to, fabricated to, or the like, execute one matrix operation associated with one or more engines, metrics, models, or the like. As another example, the transform processor 130 can alternatively be assigned to, associated with, configured to, fabricated to, or the like, execute another matrix operation associated with one or more engines, metrics, models, or the like.

Thus, the transform processor 130 can centralize, optimize, coordinate, or the like, execution of a transform process across one or more metrics, engines, models. In some implementations, the transform processor is fabricated to, configured to, or the like, execute a particular transform process with at least one of a minimum physical logic footprint, logic complexity, heat expenditure, heat generation, power consumption, or the like, with respect to one or more metrics, engines, models, and the like.

The system memory 140 can store data associated with the example processing system 100. The system memory 140 can include one or more hardware memory devices for storing binary data, digital data, or the like. The system memory 140 include one or more electrical components, electronic components, programmable electronic components, reprogrammable electronic components, integrated circuits, semiconductor devices, flip flops, arithmetic units, or the like. The system memory 140 can include at least one of a non-volatile memory device, a solid-state memory device, a flash memory device, or a NAND memory device. The system memory 140 can include one or more addressable memory regions disposed on one or more physical memory arrays. As one example, a physical memory array can include a NAND gate array disposed on a particular semiconductor device, integrated circuit device, or printed circuit board device.

The communication interface 150 can communicatively couple the system processor 110 to an external device. An external device includes but is not limited to a smartphone, mobile device, wearable mobile device, tablet computer, desktop computer, laptop computer, cloud server, local server, and the like. The communication interface 150 can communicate one or more instructions, signals, conditions, states, or the like between one or more of the system processor 110 and the external device. The communication interface 150 includes one or more digital, analog, or like communication channels, lines, traces, or the like. As one example, the communication interface 150 can include at least one serial or parallel communication line among multiple communication lines of a communication interface. The communication interface 150 can include one or more wireless communication devices, systems, protocols, interfaces, or the like. The communication interface 150 can include one or more logical or electronic devices including but not limited to integrated circuits, logic gates, flip flops, gate arrays, programmable gate arrays, and the like. The communication interface 150 can include one or more telecommunication devices including but not limited to antennas, transceivers, packetizers, wired interface ports, and the like. It is to be understood that any electrical, electronic, or like devices, or components associated with the communication interface 150 can also be associated with, integrated with, integrable with, replaced by, supplemented by, complemented by, or the like, the system processor 110 or any component thereof.

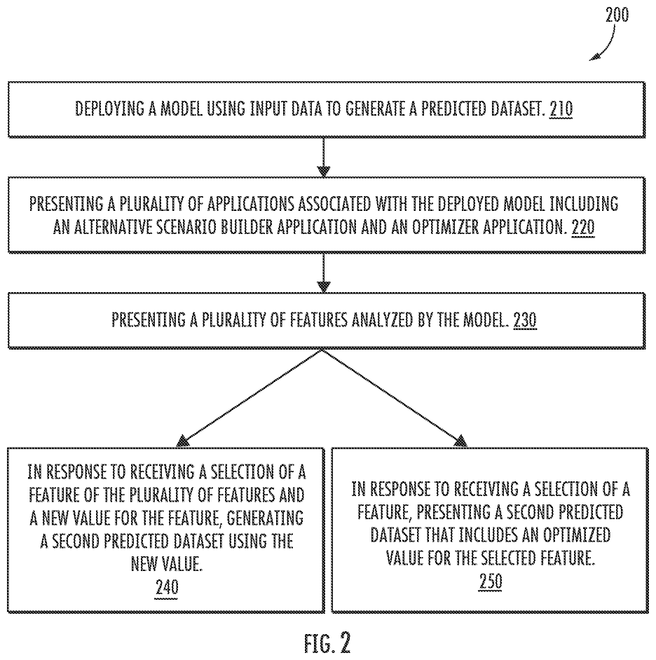

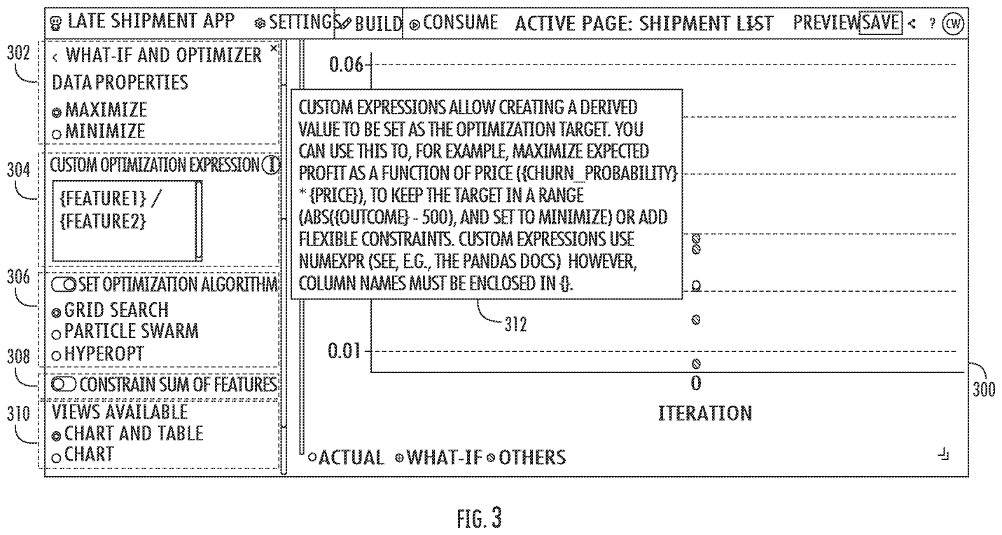

Referring now to FIG. 2, a flowchart depicting operational steps executed by a data processing system (the system) is depicted, in accordance with an embodiment. The method 100 can be performed by one or more features or components depicted in FIG. 1, including, for example, the system processor 110. Therefore, the method 200 can be performed by a processor of the data processing system. The method 200 describes how a processor or a server of the system can allow a user to generate and/or execute applications to further gain insights regarding one or more models (e.g., a deployed model) that use AI/ML methodologies to predict data.

Other configurations of the method 200 may comprise additional or alternative steps than shown, or may omit one or more steps altogether. Some of the steps of the method 200 may be executed by another processor or server (e.g., local processor on an electronic device) under direction and instructions from the system.

Using the method 200, the system may display one or more GUIs on a user computer device, such as a computer operated by a user. As used herein, the user may be a user or a customer utilizing services associated with the system. For instance, the user may be a subscriber of the services rendered by the system and may utilize the system and its various models to generate decisions or receive predicted outputs. For instance, the user may access an electronic platform (e.g., website) associated with the system and interact with various GUIs and features discussed herein to evaluate how input data can be changed to produce alternative (and sometimes better) results, generate alternative scenarios, and/or optimize certain features.

At step 210, the system may deploy a model using input data to generate a predicted dataset or a prediction dataset. A system may receive an indication that a user is interested in deploying a model to generate a set of predicted data/attributers (predicted dataset). The system may retrieve an input dataset, execute the model, and generate the predicted dataset. As used herein, a model may refer to a computer model that uses various AI/ML methodologies to ingest one or more input datasets and output one or more predicted datasets.

In a non-limiting example, a user may access a platform that includes various input elements configured to receive instructions from the user to determine how and when to execute the model. Using these input elements, the user may instruct the system to deploy the model accordingly. For instance, the user may access the platform to select a model to be deployed and select (or input/provide) the input dataset for the model to use. The input dataset may represent the data that is ingested and analyzed by the model to generate the predicted dataset.

In a non-limiting example, the input datasets may correspond to data associated with the user's business. For instance, the input dataset may include shipping data (e.g., when shipping was ordered, shipping cost, shipping method, delivery time, and the like), order data (e.g., when the order was received, when the shipment was requested, when the shipment was fulfilled), item data (e.g., when the item was purchased by the customer, price, item attributes, and the like), and other data that can be ingested by the model, such that the model can predict various attributes associated with the user's business, such as shipment efficiency. In this example, the shipment efficiency is the target or the predicted data outputted by the model. In another non-limiting example, the input dataset may include data associated with a series of loan applicants, such that the model can predict a decision (approve/deny) their loan application or predict a likelihood of loan default given each applicant's unique attributes. In some embodiments, the input dataset may also include historical data, such as historical data associated with loan applicants, profitability of the business, and the like.

Once the input dataset is identified, the model may ingest the input dataset. The model may then use various AI/ML techniques to generate the predicted dataset. The predicted dataset may represent the data that is forecasted by the model. Therefore, the predicted dataset may be defined as what the model outputs. Various attributes of the predicted dataset may be pre-defined and/or defined by the user. For instance, the user may desire the predicted dataset to include a likelihood of a loan default. In another example, the user may desire the predicted dataset to indicate a predicted shipment time or shipping efficiency. Therefore, the predicted dataset may include various data points that correspond to one or more values predicted by the model.

At step 220, the system may present a plurality of applications associated with the deployed model including an alternative scenario builder application (e.g., what-if application) and an optimizer application. The system may allow users to generate customized applications (also referred to sometimes as widgets) that can analyze the deployed model and provide further insights regarding the input dataset and output dataset. The applications discussed herein empower users to analyze the cause-and-effect of different variables on a predicted outcome. Using the applications discussed herein, users can make better informed and more actionable decisions to optimize outcomes (e.g., predicted dataset). The applications discussed herein enable users to experiment, simulate, and compare different scenarios using one or more predictive models to identify the best strategy or test ideas before committing resources. Using the applications discussed herein, users may focus on the right data to be analyzed/ingested by the model, get predictive insights with explanations, and also run simulations to get actionable prescriptive guidance on what to do next.

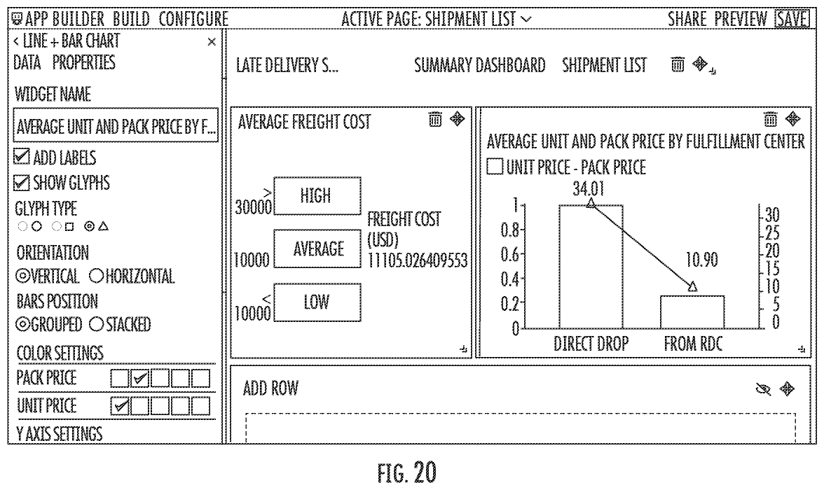

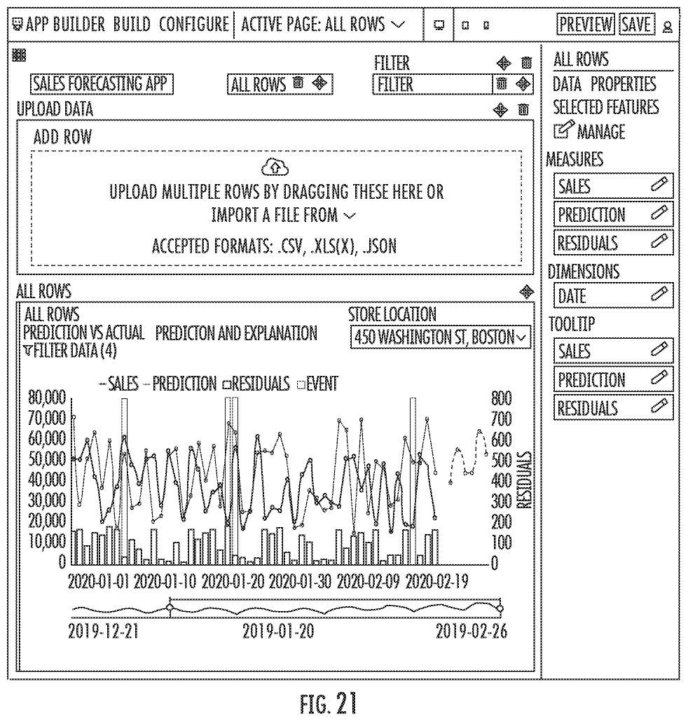

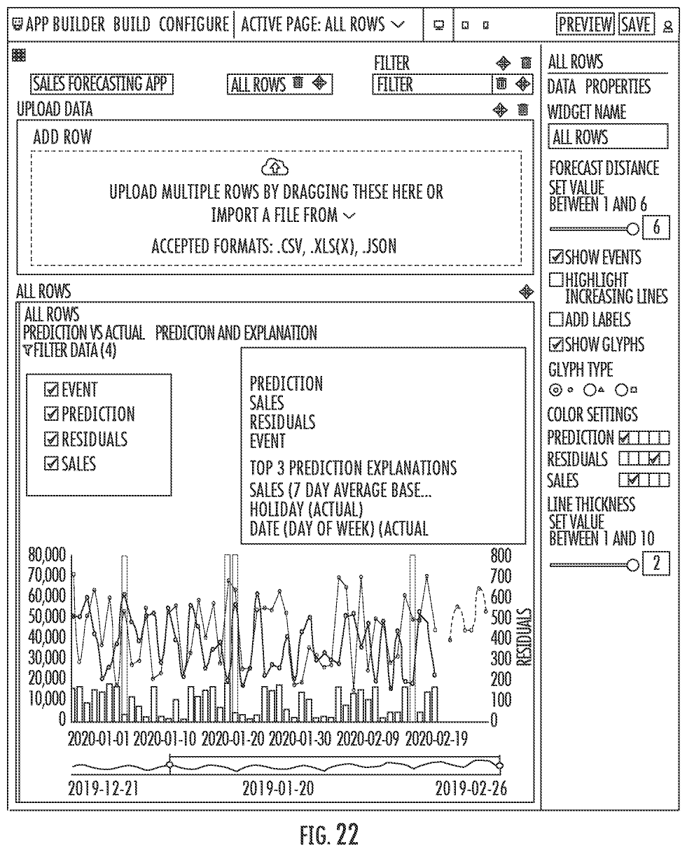

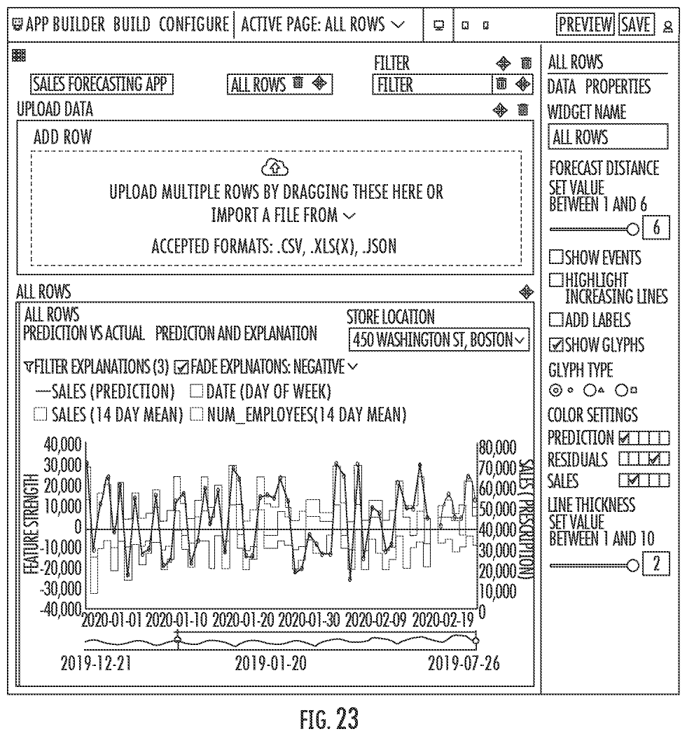

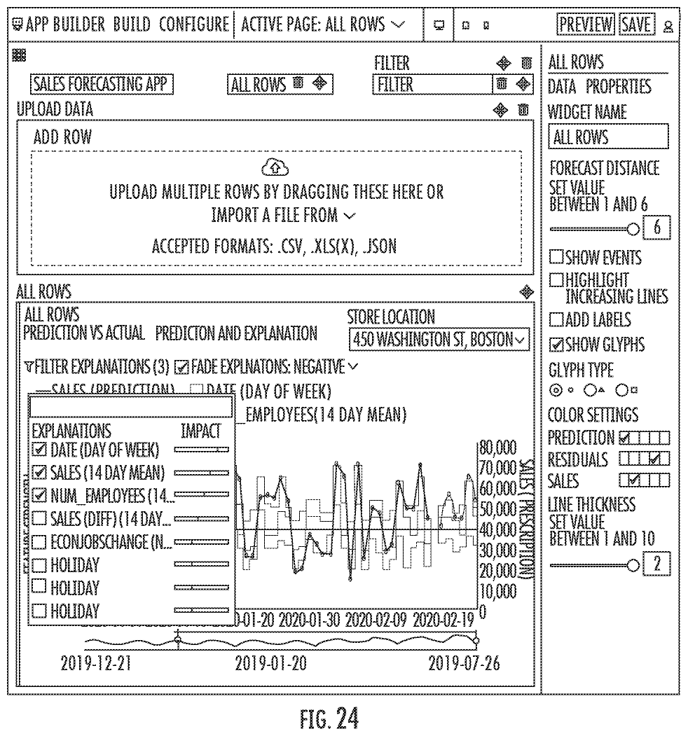

The system may provide various input elements configured to receive selections and inputs from the user, such that the user can generate the application without having any coding knowledge. These GUIs are depicted in FIGS. 6-24. Using the applications discussed herein, the user can compare forecasts with actual values for new data (e.g., generate new scenarios), provide insights on prediction explanations over time, optimize a certain feature, and “dig deeper” into the underlying reasons that the model has forecasted a certain result.

The system may allow users to share the applications with any authorized user within an ecosystem. For instance, an organization may allow users to share application data with each other to drive consistent insights and better decisions. The system may use secure authentication and/or role-based access protocols to ensure effective collaboration with individuals and groups of users. In some configurations, the system may allow the user to generate the results of execution of the application with others. For instance, the system may generate an electronic document indicating the results of execution of one or more applications, where the electronic document can be sent to others (e.g., via attachment to an email).

Using the applications discussed herein, users may make predictions one at a time or make a large batch of predictions by importing a file. Users can also compare predictions to historical results, view prediction explanations, and adjust input values to see how they impact the results.

A non-limiting example of an application is an alternative scenario builder application. The alternative scenario builder application may allow the user to make a baseline prediction, then change one or more inputs to create new scenarios and compare them side-by-side. Simply put, users may desire to use the application to answer questions such as, “do changes in the input value have the desired effect on the results?” Then, select the option that provides the best outcome.

Another non-limiting example of an application is an optimizer application. Using the optimizer application, users can run various simulations to identify the ideal combination of input values to maximize the target outcome (e.g., sales, profit, quality, cost, or speed). Users may first specify one or more constraint for the values to be optimized, apply filters to narrow down results, and identify the best scenario that works with the user's use case (e.g., scenarios that are within practical parameter limits).

Once an application is created, the application can be linked or otherwise associated with one or more models. For instance, when the user (or a system administrator) generates a customized application, the user may indicate a list of models to which the application applies.

After deploying the model (or sometimes upon receiving an instruction from the user), the system may display a list of applications. Specifically, the system may display indications associated with each application. An indication may refer to a graphical element, textual element, user interface element, or any other method of presenting an application. For instance, the system may present an icon, hyperlink, or an interactive button for each application that has been created and/or linked to the model.

By presenting a list of applications that can be executed, the system may allow the user to browse through various applications that the user (or others in the user's organization or otherwise associated with the user's account) previously created. In some embodiments, the application may be a default application that is created by a system administrator.

At step 230, the system may present a plurality of features analyzed by the model. The system may allow the user to launch an application by selecting or otherwise interacting with the indication of the application that has been presented to the user. Once an application is launched, the system may then present a list of features analyzed by the model.

The system may retrieve a list of features generated by the model. In some embodiments, the list of features may be generated by the model itself as a part of model training and/or execution. Additionally or alternatively, the features may be generated by a different model and/or using a different processes. For instance, the system may employ other models to generate features for the model to be ingested/analyzed, such that the model can output the predicted/forecasted results.

The system may display the list of features on the user interface. For instance, the system may update a portion of the user interface and display a list of features. The system may also include an indication of an impact value associated with each feature. For instance, the system may rank the features in accordance with their respective impact value. In another embodiment, the system may filter the list of features, such that the displayed features all satisfy a criteria (e.g., impact value threshold). In another embodiment, the system may display the features alongside a score indicating their respective impact value.

Before (or sometimes at any time during) deploying the model, the system may generate features based on the input dataset. Adding features to the input dataset may improve the accuracy of model and allow the model to generate a more precise/accurate predicted dataset. However, not all features may equally impact the model's performance and/or the results. The system may analyze the features to identify an importance or impact associated with each feature. As used herein, importance or impact of a feature may correspond to an impact of each feature on the model's performance (e.g., the predicted outcome). The system may calculate the effect of each feature on the overall model's performance and the predicted dataset using various methods, such as the Shapley method.

By displaying the impact value, the system may allow the users to focus on features that are relevant to the problem users are trying to solve and to avoid focusing on those features that contribute minimally to the overall predicted results. For example, if a user is trying to predict flight delays, today's temperature may be important, but the temperature three months may not be as important. As a result, the system may not display a feature that corresponds to the temperature three months ago.

If the application launched by the user is the alternative scenario builder application, the method 200 may move to the step 240. However, if the application launched by the user is the optimizer application, the method 200 may move to the step 250. In some configurations, the user may request and the system may execute both applications together. For instance, the system may optimize a feature and generate an alternative scenario.

At step 240, the system may, in response to receiving a selection of a feature of the plurality of features and a new value for the feature, generating a second predicted dataset using the new value. In response to the system receiving an indication that the user has selected one or more features, the system may simulate a scenario regarding the selected features. Good feature selection may eliminate irrelevant or redundant data without sacrificing accuracy or with minimally affecting the model's accuracy. The system may also display one or more input elements configured to receive a new value from the user. The new value may correspond to a new alternative value for which the user desires to generate a scenario.

Upon receiving the new input from the user, the system may generate a new predicted dataset based on the newly inputted value in light of the selected feature. The system may display the newly generated predicted dataset on a user interface accessible to the user. In some embodiments, the system may display the predicted dataset and the new predicted dataset at the same time, such that the user can see how various data points would change if the feature changes.

At step 250, the system may, in response to receiving a selection of a feature, present a second predicted dataset that includes an optimized value for the selected feature. Many users, especially users who are not code-savvy, struggle to understand and utilize the transformational power of AI and ML. As a result, these users miss significant opportunities to better understand their customers, optimize processes, and derive better results. Using the optimizer application, the user may instruct the system to the maximum or minimum predicted values for a target (selected feature) by varying the values of a selection of flexible features in the model.

The system may identify/determine the best numerical solution to a given problem. Optimization protocols may be executed in conjunction with various loss functions because varying a value of a feature may create losses for other features that are not desirable. Therefore, the optimization application may execute the model in light of the loss function associated with various data points. The system may use various optimization protocols, such as gradient descent to optimize the selected features or attributes.

Along with a selected feature to be optimized, the system may also receive a list of flexible features and/or constraints from the user. For instance, the user may desire to optimize a particular feature. However, the user may not desire to change all the features to achieve the optimization. In another example, the user may not desire to change various features beyond certain limits. Therefore, flexible features may correspond to features that represent the factors that the user may have control over when searching for the optimized outcome. Moreover, constraints may correspond to a threshold associated with the flexible features and may guide the optimizer application regarding the desired bounds of values to be used in the optimization. In some embodiments, the constraint may also indicate a range of the optimized value. For instance, the user may indicate a desire to optimize a feature within a particular range.

In a non-limiting example, when optimizing loans grant rate, certain features may not be in control of the user (e.g., applicant's income). However, certain other features may be controlled by the user (e.g., credit score analysis used in the overall analysis to determine whether an applicant should be granted a loan). It logically follows that if the impact of the credit score in predicting a default rate is severely reduced, the loan grant rate would increase. However, the user may not desire severely lowering the credit score requirement for practical reasons. As a result, the user may impose a constraint on the credit score flexible feature (e.g., no less than 650 credit score).

Flexible features may be identified in light of the selected feature to be optimized. That is, each feature to be optimized may include a different set of flexible features. Therefore, when the user selects a feature to be optimized, the system may display a list of corresponding flexible features where the user can further select a portion of the flexible features to be analyzed. The system may also present one or more input elements to receive corresponding constraints for each selected flexible feature. The selected/inputted constraint may instruct the application/system to only include values falling in the range determined by numeric constraints or specific values for a categorical feature within its analysis to optimize the selected feature.

The system may then present an optimized solution to the user. For instance, the system may present one or more data points that may be changed in order to optimize the selected feature.

In some configurations, the system may determine whether the new value inputted by the user and/or features selected by the user cannot be used in generating an alternative scenario and/or optimizing a value. In the alternative scenario builder application, if the selected feature has a low impact, then the system may display a notification indicating that the selected feature has a low impact and would likely not affect the new alterative scenario by much. The user may choose to ignore the warning and may continue with the alternative scenario. When the system receives a new value for which the alternative scenario is to be projected, the system may check the value to ensure that it corresponds to the selected feature. For instance, each feature may include a variable type. If the new value inputted by the user does not match the variable type, the system may display an error message informing the user that the alternative scenario cannot be generated.

Because feature are not always intuitive, users might input the wrong variable type when generating the alternative scenario. For instance, a “brand” feature may be a categorical, a “manufacturing” feature may be categorical, and a “price” feature may be numerical. However, a dosage feature or a late shipment feature may also be categorical, which may not be intuitively understood by the user, especially if the user is not code-savvy and is not experienced with featurization of AI/ML techniques. If the new value inputted by the user does not comply with the correct variable type, the system may display an error window describing the error and why the user may not continue unless the user changes the inputted value.

In the optimizer application, the user may not intuitively understand which features can be selected as flexible features. For instance, while shipment date can be intuitively understood by most users, other features might not. For instance, a feature may consist of multiple features or attributes within the input dataset. As a result, the feature might include attributes that may or may not be controllable by the user (e.g. flexible). When the user selects a feature that cannot be counted as a flexible feature, the system may display an error message describing why the selection is inappropriate.

The system may present an error message when the constraints selected or inputted by the user does not comply with certain criteria. For instance, if the constraint is not within predefined thresholds (that may correspond the feature selected feature itself), the system may display an error message. For instance, if the flexible feature corresponds to credit score of applicants, the system may retrieve a defined range of the acceptable range of credit scores and presents an error message of the constraints do not comply with the range.

In a non-limiting example, a user may deploy a model that is configured to receive an input dataset associated with orders received and shipped via a business. The model may be configured to predict business efficiency associated with the business. Specifically, the model may be configured to predict late shipment. When the user initially deploys the model, the system may output a series of predicted values including a predicted late shipment. The predicted values may be based on actual values that currently exist. However, the user may desire to see what would happen if shipment is requested on biweekly basis instead of aggregating all the orders for a week and requesting shipments of the orders on Fridays (e.g., current practice). As a result, the user may launch the alternative scenario builder application and input biweekly shipment as the new value to be analyzed. The system may use the methods and systems discussed herein to generate an alternative scenario and project a new late shipment value. The model may predict that, in the alternative scenario, late shipment value would increase.

Moreover, the user may instruct the system to optimize late shipment using the methods and systems discussed herein. As a result, the system executes the optimizer application and determines that aggregating all the shipments and requesting them on Wednesdays decreases late shipments and is the best solution (optimized solution). The model may not recommend a semi-weekly shipment request (even though in that scenario, late shipment would be truly minimized), because user-defined constraints do not allow the model to consider semi-weekly shipment requests.

Referring now to FIGS. 3-5, a non-limiting example of execution of the applications discussed herein is presented. The FIGS. 3-5 represent execution of an application that can analyze a deployed model configured to predict late shipment given various attributes associated with order data. However, concepts depicted and discussed herein apply to any other deployed (and sometime not deployed) model that uses AI/ML to predict a value.

After deploying the model, the user may be directed to the graphical user interface (GUI) 300. The GUI 300 includes various input elements configured to receive inputs from the user to generate an alternative scenario and/or optimize a particular feature. For instance, the graphical component 302 includes a radio button that allows the user to select whether to minimize or maximize a feature. The graphical component 304 includes an input element for the user to select/input the features to be revised and/or optimized. Moreover, the graphical component 306 may include various optimization algorithms that can be used to optimize the feature selected.

Different algorithms may indicate the number of simulations ran by the system. The GUI 300 may provide three options to the user (Grid Search, Particle Swarm, and Hyperopt algorithms). Alternatively, the system may select the best algorithm for the user's particular selection of features.

Grid Search algorithm may refer to an exhaustive, brute-force search of options on up to a defined number (e.g., 3) flexible features. Particle Swarm algorithm may refer to a metaheuristic strategy that tests a large number of options with up to a defined number (e.g., 30) flexible features. Finally, Hyperopt algorithm may efficiently explore fewer options on up to a defined number (e.g., 20) flexible features. With this algorithm, the user may be able to set up to 400 simulations. More iterations may yield better results, but can result in longer run times as it might take many iterations to converge.

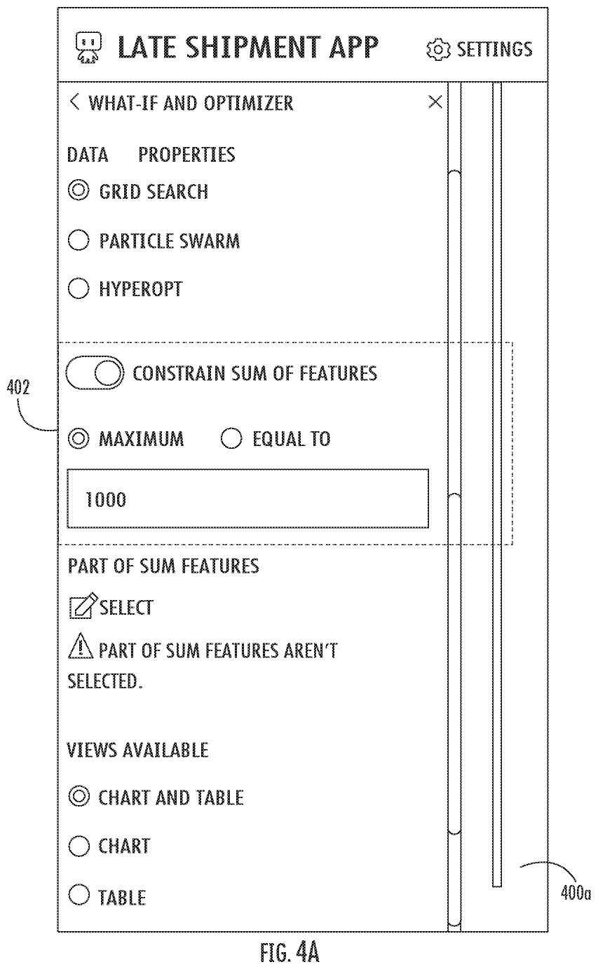

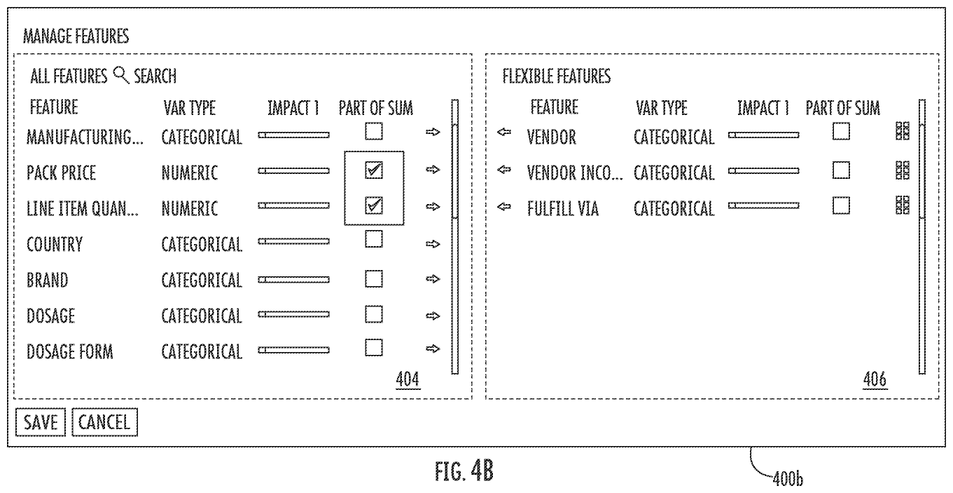

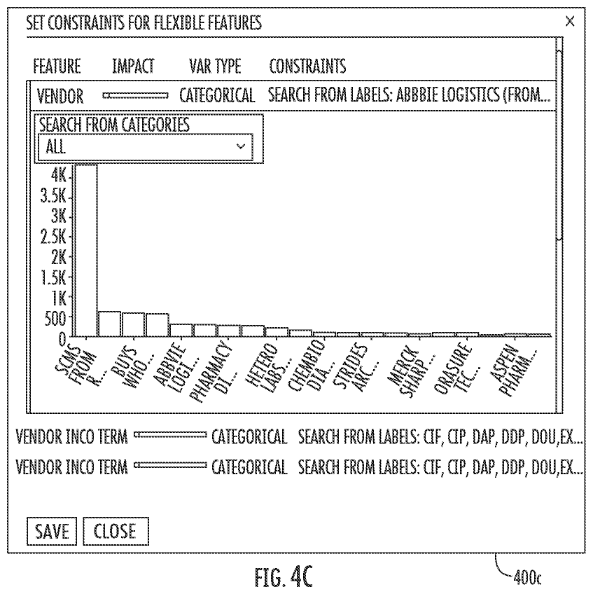

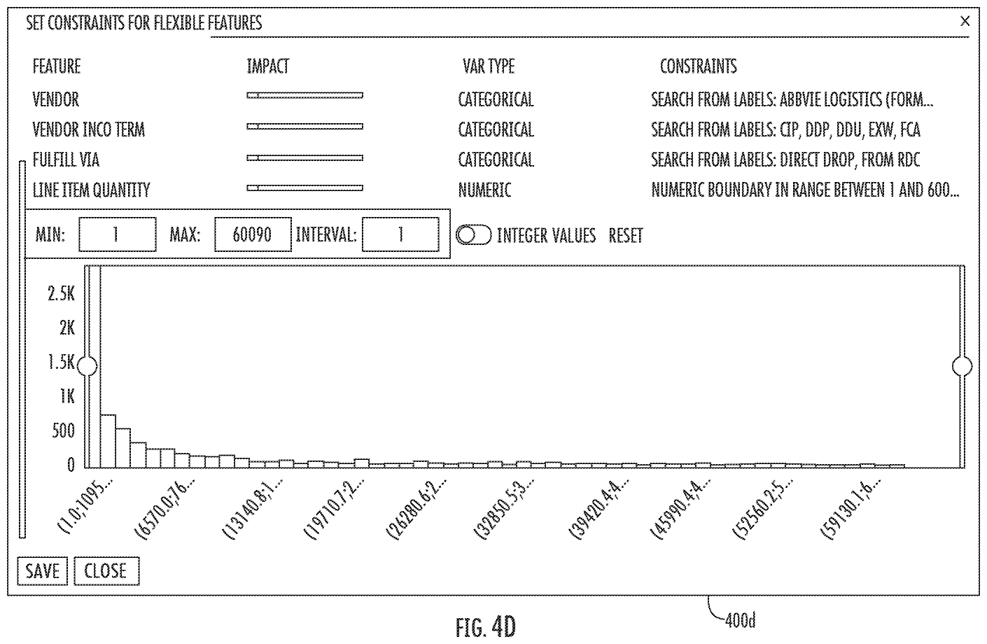

The graphical component 308 may include an input element that is configured to receive a constrain sum of features. Constraints ensure that each record's optimization iterations does not output results that exceed a given value for the target feature (feature to be optimized). For example, if a user is optimizing the price of a home, the user may want to expand the gross living area by finishing part of the basement or adding a bedroom. The user may use a sum constraint to limit the space each project is allowed to occupy in sq/ft. The user may choose maximum (selected solutions must never exceed) or equality (selected solutions must be equal) to the constrain value. These features are also depicted in FIG. 4 (graphical component 402 of GUI 400a).

Referring back to FIG. 3, using the graphical component 310, the user may select how the user desires to view the results. The GUI 300 may also include the text box 312 describing the results of the application.

The GUI 300 may also include a toggle to enable or disable the comparison functionality (enable what-if scenario). The GUI 300 may also include a toggle to enable or disable the optimizer functionality. If optimizer is enabled, the user may then select an option under outcome of optimal scenario and can include a custom optimization expression. The outcome of optimal scenario may set whether to minimize or maximize the predicted values for the target feature. Minimizing leads to the lowest outcome (e.g., custom churn), and maximizing the highest (e.g., sale price).

In some embodiments, the user may directed to the GUI 400b (FIG. 4B) for feature selection. The GUI 400b may include the graphical component 404 that displays a list of features associated with the model. The list of features may also include an indicator for their respective impact value. The list of features may also include a name for each feature and its variable type (e.g., categorical or numerical). The list of features may be filtered and/or ranked based on any of the variables depicted herein. For instance, the list of features may be ranked based on the impact value or filtered based on their variable type. The user may use input elements of the graphical component 404 to select the feature to be optimized and/or revised as an alternative scenario. The depicted features can be selected (or moved to the flexible portion) using the arrow buttons.

The GUI 400b may also include the graphical component 406 that displays a list of flexible features. These features can also be revised using the arrows shown.

The user may then be directed to the GUIS 400c-d for the user to select the constraints. Using the GUI 400c, the user may set constraints for categorical features. For instance, the user may open the “search from categories” dropdown menu and choose which features to include in the simulation by checking the corresponding box. For numeric features (GUI 400d), the user may enter individual values for the minimum and maximum numeric ranges or drag the boundaries on the histogram.

The user may also be directed to a new GUI (not shown) so that the user can select/input a new value to be used in the alternative scenario.

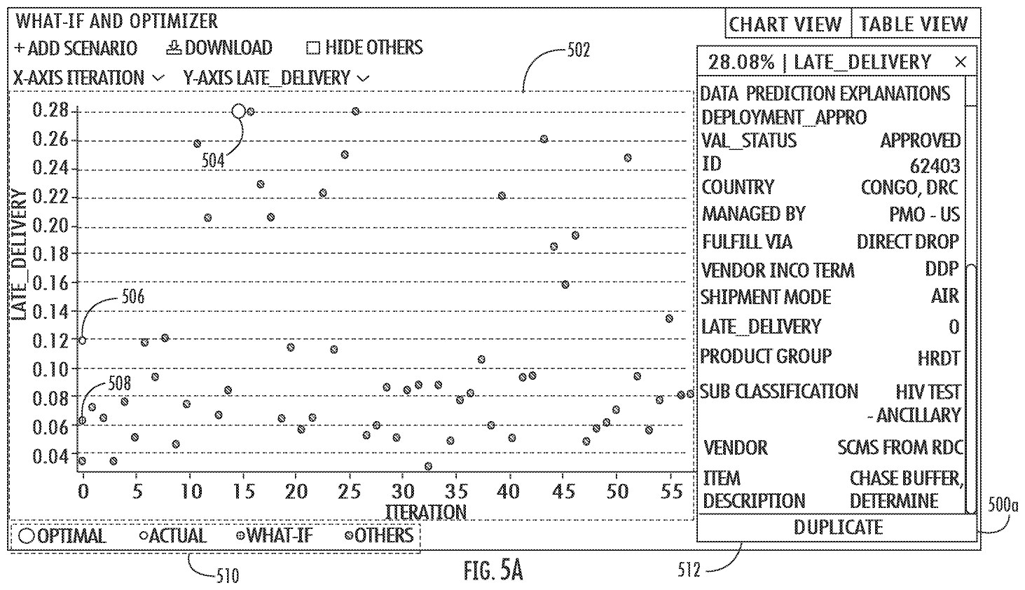

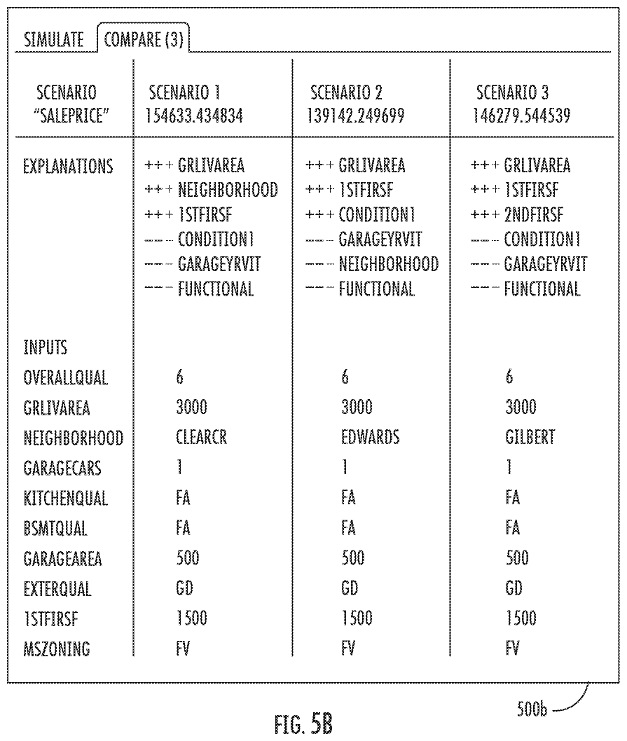

After the user sets up the optimization or the alternative scenario parameters (using the input elements discussed herein), the system may direct the user to the GUI 500a (FIG. 5A). The GUI 500a may include the chart 502 that visually depicts data points of the model (predicted dataset), a projected optimized data point (504), actual data points (506) and the alternative data points that corresponds to a new inputted value (508). The data points depicted within the chart 502 may visually correspond to the map 510. The GUI 500a may also include the graphical component 512 depicting the results of the optimization and/or alternative scenario.

The chart 502 includes various data points arranged in accordance with an X-axis corresponding to a number of iterations and a Y-axis corresponding to a feature being optimized and associated with the alternative scenario. The chart 502 may be customized, such that it shows any other attribute or feature selected by the user.

In the depicted embodiment, the user has requested to optimize (by minimizing) late deliveries. It should be noted that the actual number of late deliveries may be different than the value assigned to the late delivery feature because the late delivery feature (depicted on the Y-axis) represent a feature not the actual number of later delivery. Therefore, an increase in the depicted feature is desired.

In the depicted embodiment, the chart 502 displays what would happen to the delivery feature (alternative scenario) by analyzing the new value inputted by the user. The alternative scenario is depicted via the data point 508 while the actually (current) predicted value is depicted by the data point 506. As depicted, the new scenario is not necessarily better than the actual and current value. The system, however, may optimize the values and identify a solution to minimize late deliveries, as depicted by data point 504. When the user hovers over the data point 504, the system displays the box 512 that displays various attributes on how to achieve an optimized late delivery feature. The box 512 indicates that a projected later delivery of 0 can be achieved via changing the depicted attributes to the depicted values.

In some configurations, the user may view results of different alternative scenarios simultaneously, as depicted in the GUI 500b (FIG. 5B).

The system may also provide a series of GUIs including various input elements that are configured to allow the user to create the applications that could further provide insights regarding deployed models. These input elements may “walk thought” a series of questions that could be answered by any user without necessarily having knowledge of coding and/or AI/ML modeling. After the user has responded to the questions, the system may then generate the application accordingly.

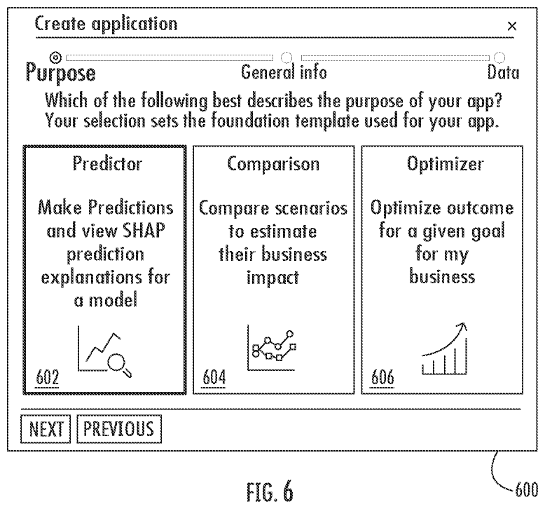

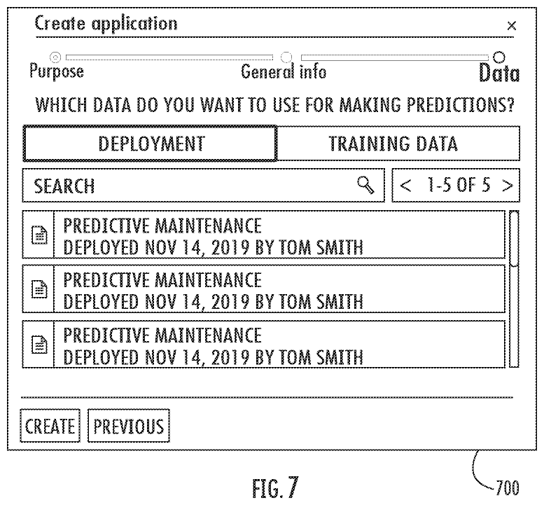

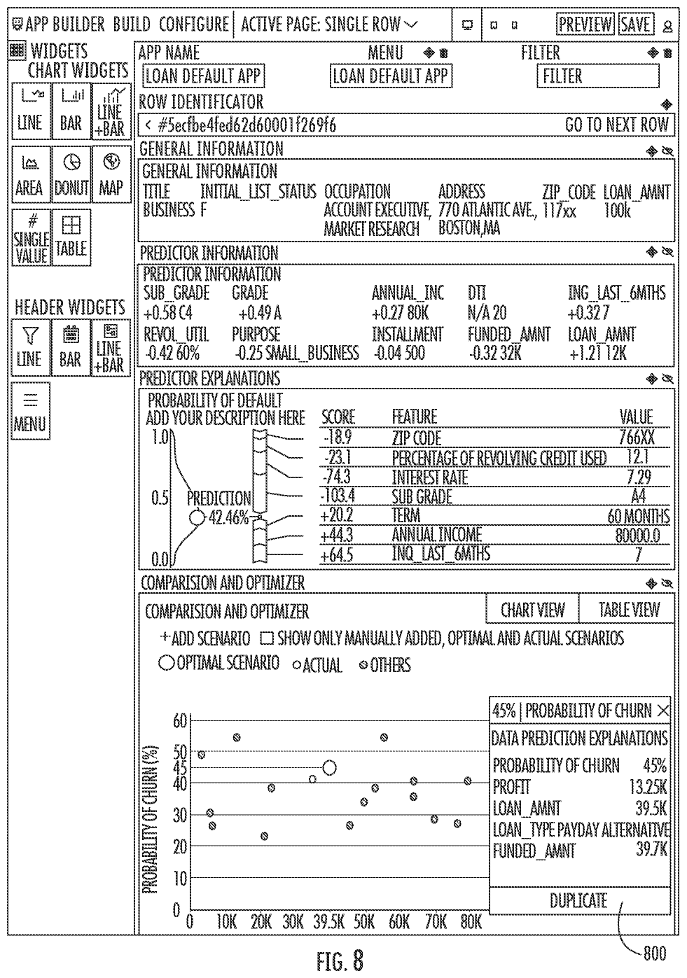

Referring now to FIG. 6, the GUI 600 provides input elements 602, 604 and 606 allowing the user to select a type of application to be created (e.g., optimizer, predictor, or what-if). The user may select the model (associated or linked to the application) using the input elements of the GUI 700 (FIG. 7). The GUI 800 (FIG. 8) may then display the scored data (resulting from deploying the model) and may display all the application/widgets variables for a particular model. The GUI 900 (FIG. 9) may allow the user to enable sharing of the application and permissions and select others who are authorized to receive (the results) of the application.

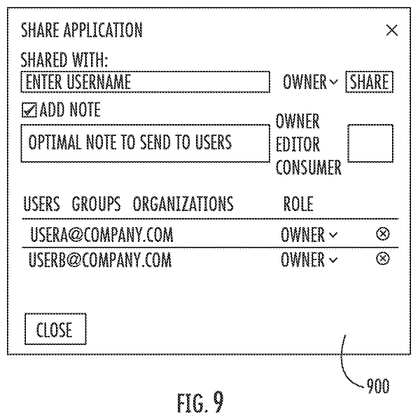

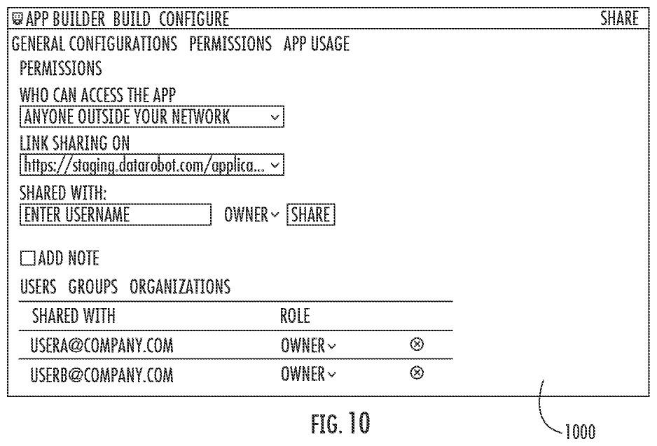

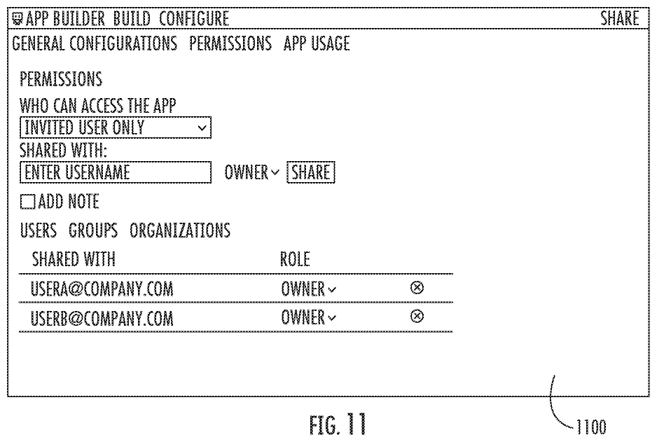

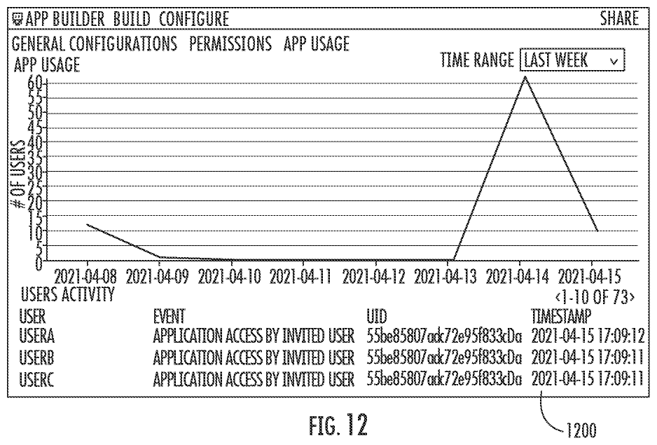

Using the GUI 1000 (FIG. 10), the user may designate others (other users) who can access the application or its resulting data. For instance, the user may view a list of users and determine who can access the application. Using the input elements of the GUI 1100 (FIG. 11), the user may restrict access of specific users to sensitive data. The user may also view activity blog and other users' activities (with respect to the selected model) using the GUI 1200 (FIG. 12). As a result, the user can determine how the model is being utilized by users before granting them access to the application that provides insights regarding the model.

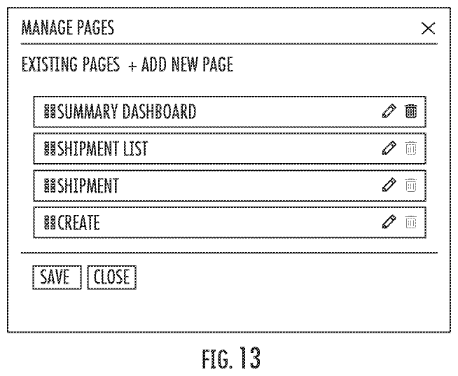

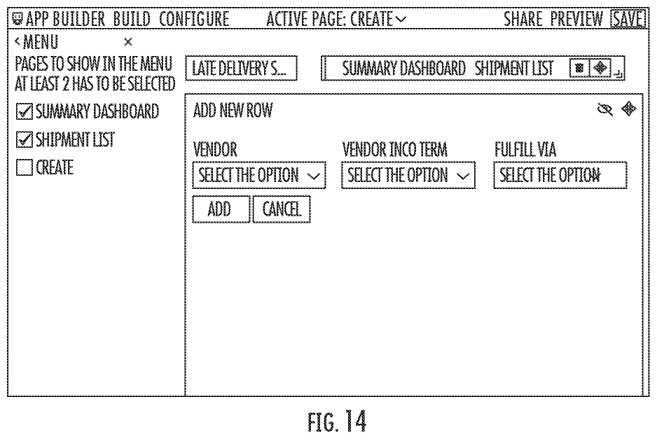

Using the GUIs depicted in FIGS. 13-14, the user may mange the pages displayed when the application is executed/launched. The user may use various input elements to customize how the application visualizes the data including what data should be included.

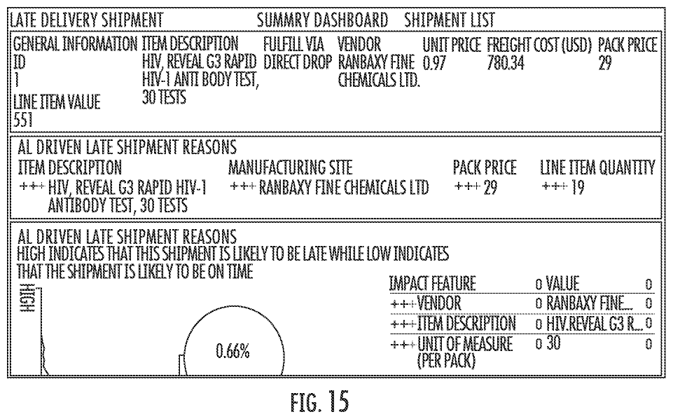

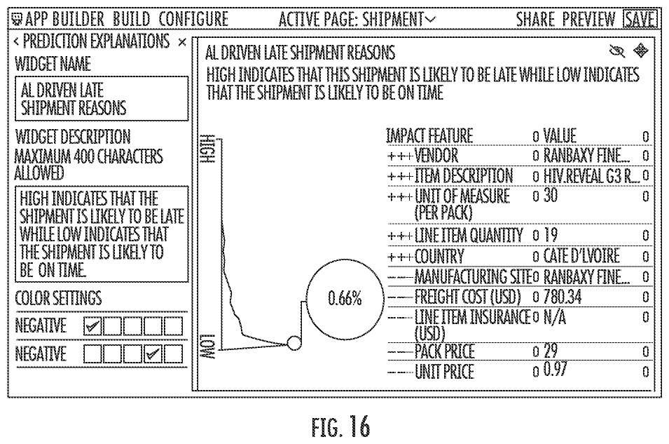

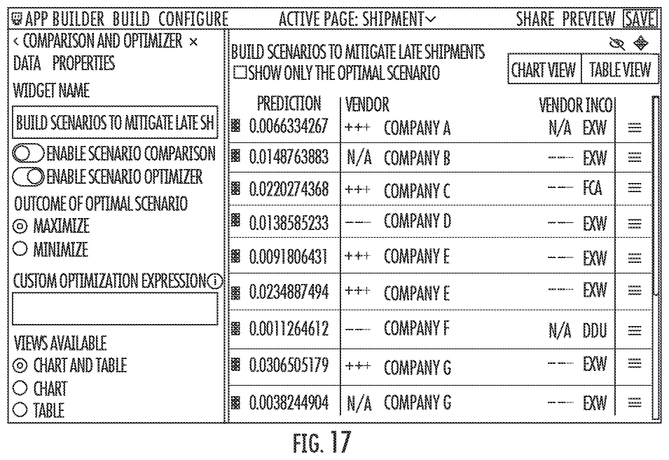

Using the responses received via the input elements, the system may configure the layout and the information displayed by each application. FIG. 15 is a GUI of a predictor application that provides an easy way to understand what is driving the output of the model. FIG. 16 is a GUI of a what-if application and optimizer application that allows a user to manually create different scenarios and compare and contrast the output and the reasoning behind them as well as automatically have the system optimize for the best scenario and understand the reasons behind all the scenarios automatically created. FIG. 17 depicts an alternative embodiment in which an alternative scenario is displayed in charts.

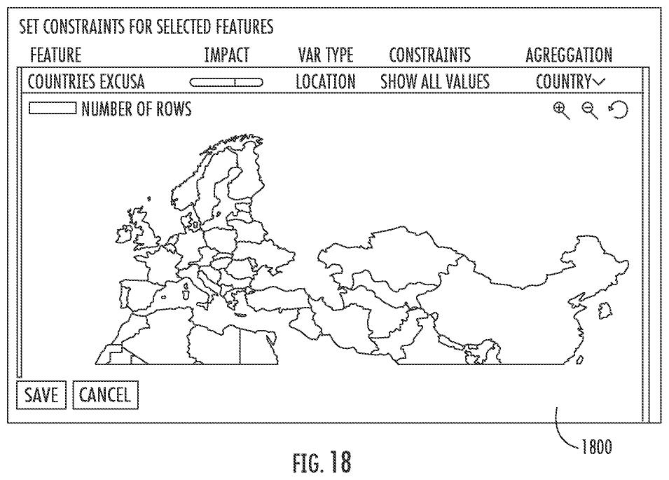

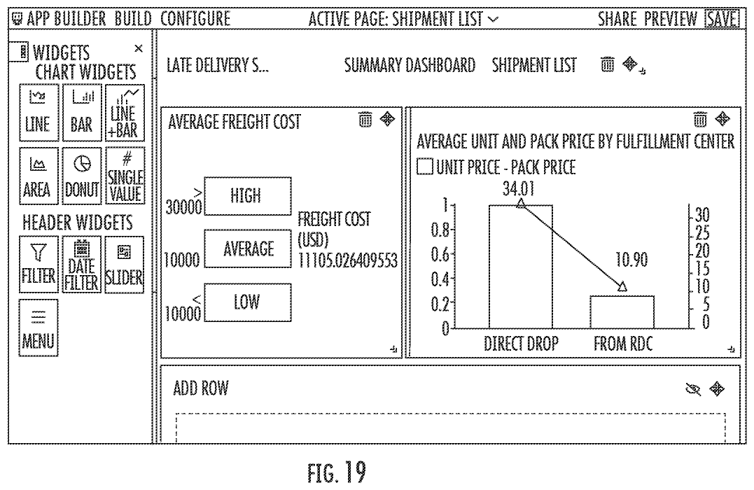

As discussed herein, the system may also allow the user to select and revise flexible features. In addition to the flexible feature selection process depicted in FIGS. 4B-4D, the system may display the GUI 1800 (FIG. 18) that display a geospatial view of features or allow the user to set constraints. FIGS. 19-24 depict various GUIs created by the applications (using the configurations inputted by the user). FIGS. 19-24 depict GUIs of Forecasted vs actuals with residuals data and explanation of forecasts over time (feature effect over time).

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A method, comprising:
deploying, by a data processing system comprising one or more processors coupled to memory, a model using input data to generate a predicted dataset via machine learning;
presenting, by the data processing system on a user interface, a plurality of indications for a plurality of applications associated with the deployed model, a first application from the plurality of applications configured to generate new scenarios and a second application from the plaurlity of applications configured to optimize at least one feature of the deployed model;
in response to receiving a selection of the first application, presenting, by the data processing system on the user interface, a plurality of features analyzed by the model;
in response to receiving a selection of a feature of the plurality of features and a new value for the feature:
presenting, by the data processing system, an error message when the new value does not comply with a defined criteria; and
executing, by the data processing system, the first application to generate a second predicted dataset using the new value.

2. The method of claim 1, comprising:
ranking, by the data processing system, the plurality of features based on an importance value of the plurality of features; and presenting, by the data processing system, the plurality of features based on the ranking.

3. The method of claim 1, wherein the plurality of features corresponds to categorical features.

4. The method of claim 1, wherein the plurality of features corresponds to numerical features.

5. The method of claim 1, further comprising:
filtering, by the data processing system, the plurality of features in accordance with an impact value threshold.

6. The method of claim 1, further comprising:
in response to receiving a selection of the second application, presenting, by the data processing system on the user interface, the plurality of features analyzed by the computer model; and
in response to receiving a selection of at least one feature, executing the second application to generate an alternative predicted dataset that includes an optimized value for the selected at least one feature.

7. The method of claim 6, further comprising:
presenting, by the data processing system, a subset of the plurality of features analyzed by the computer model as flexible feature when the subset of the plurality of features includes an attribute that contributes to the optimized value.

8. The method of claim 6, further comprising:
receiving, by the data processing system, a constraint value indicating a range of the optimized value.

9. The method of claim 1, further comprising:
presenting, by the data processing system on the user interface, a graphical indicator corresponding to a value associated with the selected feature within the predicted dataset and a second graphical indicator corresponding to a second value associated with the selected feature within the alternative predicted dataset.

10. The method of claim 1, further comprising:
generating, by the data processing system, an electronic document the second predicted dataset using the new value.

11. A computer system comprising:
a server of a data processing system comprising one or more processors coupled to memory, the server configured to:
deploy a model using input data to generate a predicted dataset via machine learning;
present, on a user interface, a plurality of indications for a plurality of applications associated with the deployed model, a first application from the plurality of applications configured to generate new scenarios and a second application from the plaurlity of applications configured to optimize at least one feature of the deployed model;
in response to receiving a selection of the first application, present, on the user interface, a plurality of features analyzed by the model;
in response to receiving a selection of a feature of the plurality of features and a new value for the feature:
present an error message when the new value does not comply with a defined criteria; and
execute the first application to generate a second predicted dataset using the new value.

12. The computer system of claim 11, wherein the server is further configured to rank the plurality of features based on an importance value of the plurality of features; and presenting, by the data processing system, the plurality of features based on the ranking.

13. The computer system of claim 11, wherein the plurality of features corresponds to categorical features.

14. The computer system of claim 11, wherein the plurality of features corresponds to numerical features.

15. The computer system of claim 11, wherein the server is further configured to filter the plurality of features in accordance with an impact value threshold.

16. The computer system of claim 11, wherein the server is further configured to in response to receiving a selection of the second application, present, on the user interface, the plurality of features analyzed by the computer model; and
in response to receiving a selection of at least one feature, executing the second application to generate an alternative predicted dataset that includes an optimized value for the selected at least one feature.

17. The computer system of claim 16, wherein the server is further configured to present a subset of the plurality of features analyzed by the computer model as flexible feature when the subset of the plurality of features includes an attribute that contributes to the optimized value.

18. The computer system of claim 11, wherein the server is further configured to generate an electronic document the second predicted dataset using the new value.

19. A computer system comprising:
a server comprising a processor and a non-transitory computer-readable medium containing instructions that when executed by the processor causes the processor to perform operations comprising:
deploying a model using input data to generate a predicted dataset via machine learning;
presenting, on a user interface, a plurality of indications for a plurality of applications associated with the deployed model, a first application from the plurality of applications configured to generate new scenarios and a second application from the plurality of applications configured to optimize at least one feature of the deployed model;
in response to receiving a selection of the first application, presenting, on the user interface, a plurality of features analyzed by the model;
in response to receiving a selection of a feature of the plurality of features and a new value for the feature:
presenting an error message when the new value does not comply with a defined criteria; and
executing the first application to generate a second predicted dataset using the new value.

20. The computer system of claim 19, wherein the instruction further cause the processor to:
in response to receiving a selection of the second application, presenting the plurality of features analyzed by the computer model; and
in response to receiving a selection of at least one feature, executing the second application to generate an alternative predicted dataset that includes an optimized value for the selected at least one feature.
